(19) United States
(12) Patent Application Publication
(10) Pub. No.: US 2006/0286962 A1
(43) Pub. Date: Dec. 21, 2006

(54) System and method for providing communication services and intervening when necessary to provide service

(75) Inventor: Michelle Davis, Plano, TX (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Evercom Systems, Inc., Irving, TX (US)

(21) Appl. No.: 11/038,471

(22) Filed: Jan. 19, 2005

(51) Int. Cl. H04M 11/00

(52) U.S. Cl. 455/405

(57) ABSTRACT

A method includes receiving a request for a communication service and determining if intervention is required to provide the communication service. The method also includes providing the communication service if no intervention is required. The method further includes performing an intervention in response to the request to gather information from at least one party associated with the request if intervention is required. In addition, the method includes providing the communication service after the intervention is completed. The gathered information is used to charge the at least one party for the communication service.

### TECHNICAL FIELD

This disclosure relates generally to communication systems and more specifically to a system and method for providing communication services and intervening when necessary to provide service.

### BACKGROUND

Many conventional communication systems use filters or other mechanisms for controlling access to services provided by the communication systems. For example, conventional communication systems often determine if a party has an associated collect call block preventing the party from receiving collect calls. If so, conventional communication systems simply block any collect calls to the party.

A problem with conventional communication systems is that requests for service are often blocked using these filters or other mechanisms. Each request for service that is blocked typically represents a request for which revenue is lost. As a result, this often reduces the revenue that may be generated and collected by the service providers operating the conventional communication systems.

### SUMMARY

This disclosure provides a system and method for providing communication services and intervening when necessary to provide service.

In one aspect, a method includes receiving a request for a communication service and determining if intervention is required to provide the communication service. The method also includes providing the communication service if no intervention is required. The method further includes performing an intervention in response to the request to gather information from at least one party associated with the request if intervention is required. In addition, the method includes providing the communication service after the intervention is completed. The gathered information is used to charge the at least one party for the communication service.

In a particular aspect, determining if intervention is required includes determining whether particular conditions are met or fail to be met. For example, intervention may be needed if the at least one party is a new customer of a service provider receiving the request or if a valid billing mechanism is not available for billing the at least one party for the communication service. Intervention may also be needed if a valid payment mechanism is not available to allow the at least one party to pay for the communication service or if a valid billing name and address associated with the at least one party is not available. Intervention may be needed if a score associated with the at least one party is not acceptable or if a balance associated with the at least one party is not acceptable. The score may be based at least partially on one or more of: a payment history of the at least one party and a credit history of the at least one party.

In another particular aspect, determining if intervention is required includes using conditions arranged in a hierarchy. The conditions are evaluated based on their positions in the hierarchy. For example, intervention could be required when the at least one party is a new customer. Some, many, or all of the other conditions need not be evaluated if this one condition (party is a new customer) is true.

In yet another particular aspect, determining if intervention is required is performed in real-time.

Other technical features may be readily apparent to one skilled in the art from the following figures, descriptions, and claims.

### BRIEF DESCRIPTION OF DRAWINGS

For a more complete understanding of this disclosure, reference is now made to the following description, taken in conjunction with the accompanying drawings, in which:

FIG. 1 illustrates an example system for providing communication services and intervening when necessary to provide service according to one embodiment of this disclosure;

FIG. 2 illustrates an example service provider network for providing communication services according to one embodiment of this disclosure;

FIG. 3 illustrates a second example service provider network for providing communication services according to one embodiment of this disclosure;

FIG. 4 illustrates a third example service provider network for providing communication services according to one embodiment of this disclosure;

FIGS. 5A and 5B illustrate an example method for providing communication services and intervening when necessary to provide service according to one embodiment of this disclosure;

FIG. 6 illustrates an example method for determining whether a service provider should intervene in a communication attempt according to one embodiment of this disclosure; and

FIG. 7 illustrates an example method for resolving billing issues during an established communication session according to one embodiment of this disclosure.

### DETAILED DESCRIPTION OF EXAMPLE EMBODIMENTS

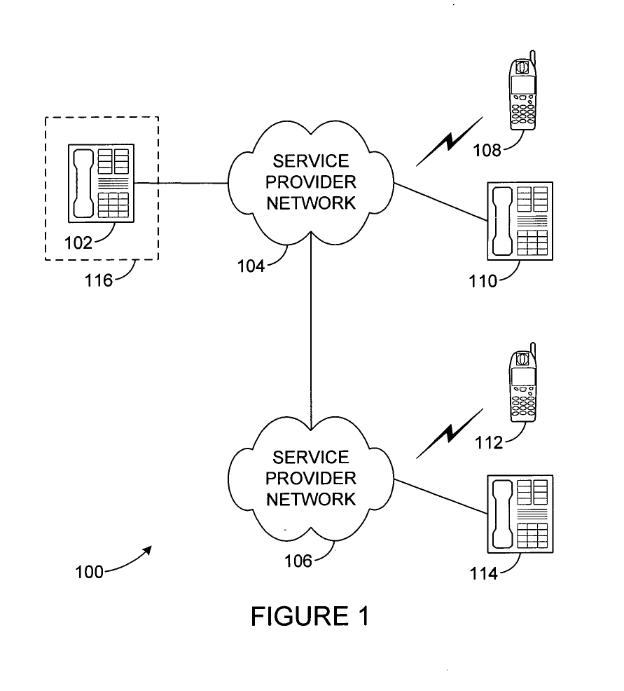

FIG. 1 illustrates an example system 100 for providing communication services and intervening when necessary to provide service according to one embodiment of this disclosure. In the illustrated example, the system 100 includes an originating terminal 102, a first service provider network 104, a second service provider network 106, and one or more end terminals 108-114. Other embodiments of the communication system 100 may be used without departing from the scope of this disclosure.

In this example embodiment, the originating terminal 102 is coupled to the first service provider network 104, and the end terminals 108-114 are each coupled to the first service provider network 104 or the second service provider network 106. In this document, the term “couple” and its derivatives refer to any direct or indirect communication between two or more elements, whether or not those elements are in physical contact with one another. Also, the term “each” refers to every of at least a subset of the identified items.

The originating terminal 102 and the end terminals 108-114 each represents any device capable of communicating over one or more service provider networks 104-106. For example, the originating terminal 102 and the end terminals 108-114 could represent devices capable of communicating voice information, data, video information, and/or graphic information over one or more service provider networks 104-106. In particular embodiments, the originating terminal 102 and the end terminals 108-114 represent fixed telephones, mobile telephones, videophones, computing devices, personal digital assistants, or any other or additional computing or communication devices.

The terms “originating” and “end” are used here to illustrate that the terminal 102 may initiate a collect call or other communication service that is received by one or more of the terminals 108-114. Also, the phrase “calling party” may be used to refer to the user of the originating terminal 102, and the phrase “called party” may be used to refer to the user of an end terminal 108-114. The terms “originating” and “end” and the phrases “calling party” and “called party” are for ease of illustration and explanation only. The terminal 102 may be capable of receiving collect calls or other communication services that are originated by one or more of the terminals 108-114. In that case, the user of the terminal 102 may be the called party, and the user of an end terminal 108-114 may be the calling party.

The originating terminal 102 may be situated in any suitable location or locations. For example, in some embodiments, the originated terminal 102 is located within a secure facility 116, such as a prison, jail, or other controlled environment. The end terminals 108-114 may also be situated in any suitable location or locations. For example, in some embodiments, the end terminals 108-114 may be fixed in homes or businesses and/or the end terminals 108-114 may be portable and used in multiple locations.

The service provider networks 104-106 are each coupled to one or more of the terminals 102, 108-114. The service provider networks 104-106 are also coupled to one another. The service provider networks 104-106 are capable of individually and/or collectively providing communication services to the terminals 102, 108-114. For example, the service provider networks 104-106 may establish voice telephone connections between two or more of the terminals 102, 108-114. As another example, if a party receiving a telephone call does not accept the call (such as by not answering the call), the service provider networks 104-106 may provide a messaging service where the calling party leaves a message for later delivery to the called party. The service provider networks 104-106 include any hardware, software, firmware, or combination thereof for providing one or more communication services to the terminals 102, 108-114. The service provider networks 104-106 may also operate according to any suitable protocol or protocols, including circuit-switched and/or packet-switched protocols.

In one aspect of operation, a party using the originating terminal 102 may request service from the first service provider network 104. The requested service could represent a request for a communication service involving one or more of the end terminals 108-110 coupled to the first service provider network 104 and/or one or more of the end terminals 112-114 coupled to the second service provider network 106.

Before providing the requested communication service, conventional service provider networks determine whether the requested communication service should be provided. For example, the requested communication service could represent a collect call placed to a mobile telephone (end terminal 108 or 112). In this case, conventional service provider networks may block the requested communication service. Other or additional requests for service may be blocked by the conventional service provider networks for any number of reasons.

To help reduce or eliminate the blocking of requested communication services, the first service provider network 104 determines whether a requested service can be charged to one or more parties and how to charge the one or more parties. If the requested service can be charged using a particular billing or payment mechanism, the first service provider network 104 provides the requested communication service.

Otherwise, if the requested service cannot be charged using any suitable billing or payment mechanism, the first service provider network 104 intervenes in the communication path. At this point, the first service provider network 104 attempts to establish a billing or payment mechanism to pay for the requested communication service. As an example, the first service provider network 104 may request that the called party using one of the end terminals 108-114 establish a prepaid account. If and when a billing or payment mechanism is established, the requested communication service may be provided.

In this way, the first service provider network 104 may block fewer or no requests for service. Instead, the first service provider network 104 takes steps to establish a billing or payment mechanism or otherwise collect any information needed to provide service at the point of demand. This means that the first service provider network 104 takes steps immediately in response to a request or demand for service, rather than taking steps at a later time (such as after a predetermined amount of time has elapsed since a request for service is blocked). By attempting to collect information or perform other actions at the point of demand, the first service provider network 104 may reject fewer requests for communication services and provide services more often. This may help to increase the revenue generated by the first service provider network 104 and collected by the service provider.

Any suitable billing or payment mechanism or mechanisms may be used to charge parties for requested communication services. For example, a prepaid account may be used to pay for communication services requested by the originating terminal 102. A prepaid account may also be used to pay for communication services used to contact a particular end terminal or group of end terminals 108-114. Also, a service provider billing account may be used by the first service provider network 104 to bill the second service provider network 106 for services provided to one or more end terminals 112-114 coupled to the second service provider network 106. Further, a credit card payment mechanism and/or a “check by phone” payment mechanism could be supported by the first service provider network 104. In addition, a direct billing account may be used to directly bill a party using an end terminal 108-114, such as by mailing a bill directly to the party.

Moreover, the first service provider network 104 could have a desired or targeted billing or payment mechanism preferred by the service provider that operates network 104. For example, the service provider could prefer that prepaid accounts be used to pay for service. The service provider could also have an ordering of preferred billing or payment mechanisms, such as when the service provider prefers prepaid accounts over collect calls and collect calls over credit card payments. The first service provider network 104 could take these considerations into account by, for example, offering the billing or payment mechanisms to the call parties in a particular order.

The establishment of a billing or payment mechanism may be performed in any suitable manner. This may include, for example, using an automated interactive voice response (“IVR”) system or a call center staffed by live operators. The establishment of the billing or payment mechanism may also be performed at any suitable time. As an example, some parties may choose to establish a prepaid account ahead of time, while other parties may wait and establish a prepaid account after a request for service is received.

In particular embodiments, the establishment of the billing or payment mechanism may be performed in real-time. For example, the billing or payment mechanism may be established after a request for service is received and before or during the requested service. As a particular example, a collect call may be placed from the originating terminal 102 in a controlled environment 116, such as a prison. The first service provider network 104 may determine if there is a valid mechanism for billing or paying for the collect call, such as a prepaid account associated with the calling party or the called party. If there is no prepaid account, the originating terminal 102 may be placed on hold while an IVR system or call center attempts to contact the called party. The called party may agree to establish a prepaid account, such as by providing a valid credit card number that is successfully charged for a suitable amount. Once the prepaid account is established, the telephone call is allowed to proceed.

The first service provider network 104 may determine whether intervention is necessary using any suitable mechanism. For example, the first service provider network 104 could use multiple conditions to determine whether a requested communication service can be charged to one or more parties and how it will be charged to one or more of the parties.

In some embodiments, the first service provider network 104 uses a hierarchy of conditions that determine whether a requested communication service can be charged and how it will be charged. If the hierarchy of conditions fails to establish that a requested service can be charged or how the service will be charged, the first service provider network 104 may determine that intervention is necessary.

The first service provider network 104 may use any suitable business logic or other logic to make determinations as to how a requested service can be charged and/or if the requested service should be charged. The first service provider network 104 may also use any suitable information to make these determinations. For example, the first service provider network 104 could use information identifying whether the called party in a collect call is a new or existing customer of the service provider and whether a valid billing mechanism or payment mechanism is known for the called party. The first service provider network 104 could also use information indicating whether the called party has a valid billing name and address (“BNA”). In addition, the first service provider network 104 could use credit information and the current balance owed by the called party. Using this information or other or additional information, the first service provider network 104 may determine whether the called party can be billed for a requested service or whether the called party must pay for the requested service up front.

As a particular example, a called party in a collect call may have a history of non-payment for collect calls. In this case, logic in the first service provider network 104 may indicate that the called party should not be billed directly for the collect call. Instead, the logic may indicate that the called party should be required to establish a prepaid account before the collect call is established. At that point, the first service provider network 104 may place the calling party in the collect call on hold while an attempt is made to have the called party establish a prepaid account. As another particular example, if the called party has a history of making timely payments for collect calls, the first service provider network 104 may allow the collect call to proceed and either bill the called party's service provider or directly bill the called party if a BNA exists.

The first service provider network 104 could also use information that is not related to the specific calling party or called party to make a determination as to how to charge one of the parties for a service. For example, the first service provider network 104 could use the locations of the calling party and the called party to determine if a calling party or called party must first establish a prepaid account. As a particular example, the called party could reside in a neighborhood, where the residents collectively fail to pay for collect calls at a high rate. In this example, the first service provider network 104 could require that the called party first establish a prepaid account before allowing a collect call to proceed. Otherwise, if the residents of the called party's neighborhood collectively fail to pay for collect calls at a low rate, the first service provider network 104 could allow the collect call to proceed. The first service provider network 104 then bills the called party's service provider or the called party directly.

The various conditions described above could be placed into a hierarchy of conditions and evaluated based on their positions in the hierarchy. The hierarchy allows the various conditions to be evaluated and examined in a suitable order so that a final decision regarding billing can be made quickly. For example, intervention could be required when the called party is a new customer. In this case, all other conditions in the hierarchy could be ignored and not evaluated since this one condition indicates that intervention is required. The next conditions in the hierarchy could be to determine whether any valid payment or billing mechanisms are available. If there are, the next conditions could determine whether a valid BNA exists for a party to be billed. If so, the next conditions could determine whether a credit score, payment history, or current balance indicates that a billing mechanism could be used. By using a hierarchy, more important conditions are evaluated first, which could reduce the amount of time needed to determine if intervention is required. The hierarchy described above is for illustration only. Other hierarchies including these or other conditions could also be used.

Beyond that, the first service provider network 104 could monitor a communication service as it is provided to one or more parties and dynamically determine if and when a billing issue arises. For example, the first service provider network 104 could monitor a collect call and identify when the balance of a prepaid account falls below one or more thresholds. If and when that occurs, the first service provider network 104 may again decide whether to intervene and interrupt the communication service. As another example, the first service provider network 104 could determine when call forwarding or conference calling features are invoked during a call (which may increase the cost of the call). Once again, the first service provider network 104 could identify when the balance of a prepaid account falls below one or more thresholds and take action. As a particular example, if the balance of a prepaid account falls below a threshold (such as $20.00), the first service provider network 104 could generate an audible warning or signal informing the parties that the balance has fallen below the threshold. If the balance of the prepaid account falls below a second threshold (such as $5.00), the first service provider network 104 may examine the called party's credit rating or payment history and determine if the called party could be billed (directly or through the called party's service provider) when the account balance reaches zero. If the called party should not be billed, the first service provider network 104 may give the called party the option of replenishing the prepaid account or continuing the collect call until the account is totally exhausted.

As another example, the first service provider network 104 could perform silence detection or pattern recognition to determine if the parties to a call are speaking often or remaining silent. If the parties are speaking a lot during a call, the first service provider network 104 could decide to increase the credit limit of the party paying for the call.

Further, the first service provider network 104 could determine that business logic that would ordinarily block service requests and force intervention may be overridden or ignored under certain circumstances. For example, the first service provider network 104 could determine that business logic blocking call conferencing may be overridden during holidays such as Mother's Day. This may allow, for example, an inmate in prison to simultaneously talk to his or her mother and grandmother.

In addition, the first service provider network 104 could provide a requested communication service and then interrupt the service after a limited amount of time. For example, when a called party owes money for prior collect calls, the first service provider network 104 could allow a new collect call to be established for ten seconds. During that time, the calling and called parties may communicate. After the ten seconds elapse, the first service provider network 104 places the calling party on hold and informs the called party that the called party currently has an unpaid balance on his or her account. The called party is then given the option of paying the balance and pre-paying for the new collect call. If the called party agrees, the balance is paid and a prepaid account is created or replenished, and the new collect call proceeds. Otherwise, if the called party refuses, the new collect call may be terminated.

In this way, the first service provider network 104 may more effectively ensure that provided communication services are either paid for in advance or are billed to parties who are more likely to pay the charges. Also, the first service provider network 104 may provide communication services in more situations and block fewer attempts to receive service, which may help to increase the revenue collected by the service provider.

Although FIG. 1 illustrates one example of a system 100 for providing communication services and intervening when necessary to provide service, various changes may be made to FIG. 1. For example, any number and type of terminals 102, 108-114 may be coupled to each of the service provider networks 104-106. Also, the system 100 may include any number of service provider networks 104-106. Further, the functionality described above as being implemented in the first service provider network 104 could be implemented in the second service provider network 106 instead of or in addition to being implemented in the first service provider network 104. In addition, multiple originating terminals 102 may or may not reside in one or multiple controlled facilities 116.

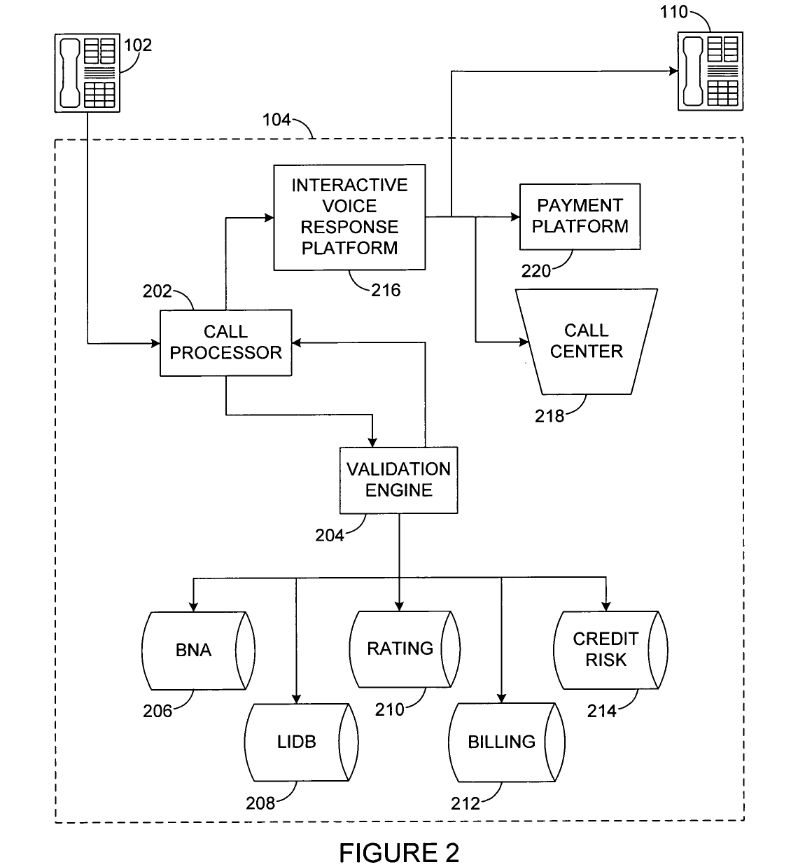

FIG. 2 illustrates an example service provider network 104 for providing communication services according to one embodiment of this disclosure. In this example, the service provider network 104 is shown as providing communication services between an originating terminal 102 and an end terminal 110 that are both coupled to the service provider network 104. The service provider network 104 could also be used to provide communication services between an originating terminal 102 coupled to the service provider network 104 and an end terminal coupled to another service provider network. The embodiment of the service provider network 104 shown in FIG. 2 is for illustration only. Other embodiments of the service provider network 104 may be used without departing from the scope of this disclosure.

In the illustrated example, the service provider network 104 includes a call processor 202. The call processor 202 receives requests for communication services from the originating terminal 102. For example, the call processor 202 may receive dual-tone multi-frequency (“DTMF”) signals from the originating terminal 102, where the DTMF signals indicate that a collect telephone call is being placed to the end terminal 110. The call processor 202 also communicates with other components in the service provider network 104 to determine whether the requested communication service should be provided. If so, the call processor 202 connects the originating terminal 102 to the called end terminal 110. As an example, the call processor 202 may determine how to route a telephone call through the system 100 and select which services in the system 100 to provide. The call processor 202 includes any hardware, software, firmware, or combination thereof for processing requests for services and providing requested services.

A validation engine 204 is coupled to the call processor 202. The validation engine 204 is capable of determining whether a requested service should be provided. For example, the validation engine 204 could determine if and how charges for a requested service should be billed or paid for by one or more of the parties. As a particular example, the validation engine 204 could determine whether the called party in a collect call has a credit score or payment history indicating a likelihood of paying for the collect call. After the validation engine 204 determines if a requested service should be provided, the validation engine 204 informs the call processor 202, which uses the results from the validation engine 204 to accept or reject a request. The validation engine 204 includes any hardware, software, firmware, or combination thereof for validating requests for service. As a particular example, the validation engine 204 may include one or more processors and one or more memories capable of storing data and instructions used by the one or more processors.

The validation engine 204 may use any suitable information to validate a request for a communication service. In this example embodiment, the validation engine 204 has access to five different databases 206-214 containing information used by the validation engine 204. In this example, the database 206 stores billing name and address or “BNA” information. BNA information includes various customers' names and addresses. The information in the database 206 is used by service providers to bill the customers for services provided to the customers.

The database 208 represents a line information database (“LIDB”). The database 208 contains information from Regional Bell Operating Companies (“RBOCs”), local exchange carriers (“LECs”), or other service providers associated with various telephone numbers. For example, the database 208 may contain information identifying the service provider that is associated with a particular telephone number. As other examples, the database 208 may contain information indicating whether a telephone number belongs to a mobile telephone or whether a collect call block has been placed on a telephone number.

The database 210 contains information identifying ratings that are associated with called and/or calling parties. For example, the ratings may identify a particular called party's propensity to pay for collect calls or other charges. The ratings may also identify the likelihood that called parties in particular neighborhoods pay for collect calls or other charges. The ratings may be generated, received, and/or collected in any suitable manner.

The database 212 contains billing information for the calling and/or called parties. For example, the database 212 may contain information identifying an amount that has been charged to a called party for prior collect calls accepted by the called party. The database 212 may also contain information identifying an amount that has been previously billed to the called party and whether the called party has paid the bill. The database 212 may further contain information about prepaid accounts established to pay for communication services.

The database 214 contains information about the credit risks or credit histories of the calling and/or called parties. For example, the information in the database 214 may identify a calling party or called party's credit score. The credit score may be generated by the service provider network 104, retrieved from one or more credit bureaus, or otherwise collected.

The validation engine 204 uses the information in the databases 206-214 to determine whether a requested service should be provided and to determine how to charge one or more of the parties for the requested service. For example, the validation engine 204 may use the database 206 to determine if a called party can be billed directly for a collect call. The validation engine 204 may use the database 208 to determine if a called party has a collect call block placed on his or her telephone. The validation engine 204 may use the database 210 to determine if a called party has a history of paying for collect calls. The validation engine 204 may use the database 212 to determine if a called party has already accepted an excessive number of collect calls. Finally, the validation engine 204 may use the database 214 to determine if a called party should be billed for a collect call or required to pay for the collect call up front.

In particular embodiments, the information in one or more of the databases 206-214 is accessible in real-time by the validation engine 204. This represents only examples of the various ways in which the validation engine 204 may use the information in the databases 206-214. The information may be used in any other or additional ways without departing from the scope of this disclosure.

If a requested communication service may be provided without any further interaction, the call processor 202 may establish or otherwise provide the requested service. Otherwise, some form of intervention may be required to provide the requested service. For example, the calling or called party may be required to establish or replenish a prepaid account to pay for the requested service. As another example, the calling or called party may be required to pay an outstanding debt before the requested service is provided.

To support this intervention with the called and/or calling party, the service provider network 104 includes one or more intervention units, such as an interactive voice response (“IVR”) platform 216 and a call center 218. The IVR platform 216 represents an automated system capable of interacting with one or more of the parties associated with a requested communication service. The IVR platform 216 may provide any suitable information to the calling and/or called party, such as a warning about the need to establish or replenish a prepaid account. The IVR platform 216 may also collect any suitable information from the calling and/or called party, such as a credit card number used to establish or replenish a prepaid account. The IVR platform 216 could further generate audible warnings during a communication session, such as a warning that a collect call will be terminated because a prepaid account is nearly exhausted. The IVR platform 216 includes any hardware, software, firmware, or combination thereof for automated interaction with one or more parties.

The call center 218 represents a center staffed by live operators who may interact with a calling and/or called party. For example, a live operator in the call center 218 may interact with a called party to obtain the called party's credit card number. The live operator in the call center 218 may also provide customer support, answering any questions that a party may have regarding available services, charges billed to a party, payment addresses, or any other or additional issues.

To facilitate payment for requested services, the service provider network 104 includes a payment platform 220. The payment platform 220 is capable of facilitating payment for requested communication services using one or more suitable payment mechanisms. For example, the payment platform 220 may support the real-time charging of credit cards to establish or replenish a prepaid account. The payment platform 220 could also support the real-time decrementing of prepaid account balances and real-time check by telephone transactions. The payment platform 220 includes any hardware, software, firmware, or combination thereof for facilitating payment for services.

The functions provided by the various components in the service provider network 104 may allow fewer requests for service to be blocked. Instead, the service provider network 104 may intervene and collect any information needed to provide service at the point of demand. This may help to increase the revenue generated by the service provider network 104.

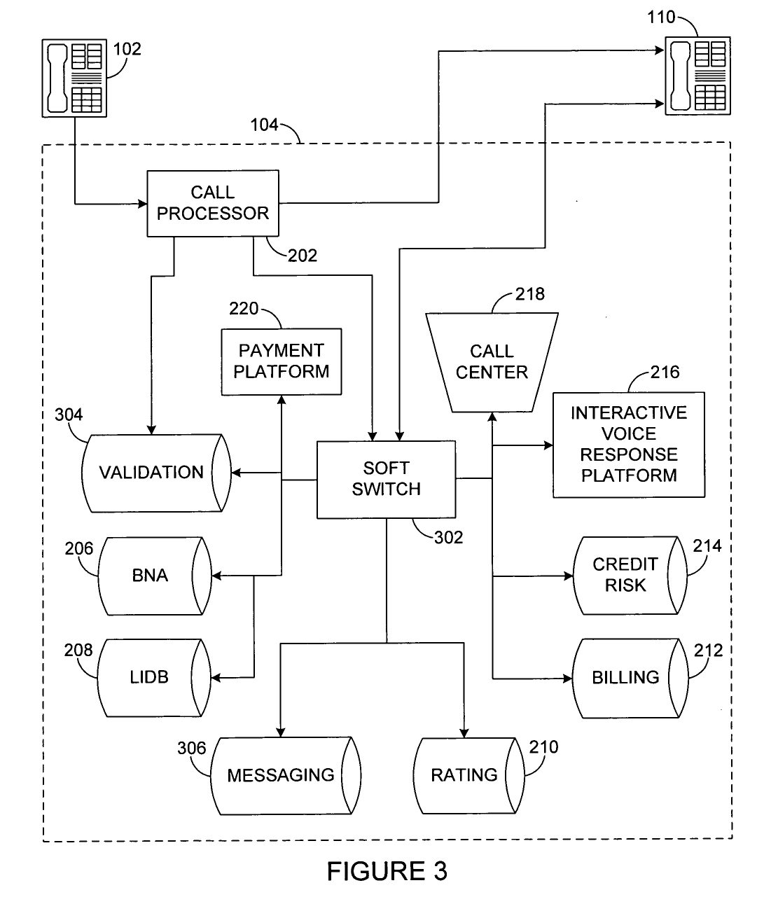

FIG. 3 illustrates a second example service provider network 104 for providing communication services according to one embodiment of this disclosure. In this example, the service provider network 104 is shown as providing communication services between an originating terminal 102 and an end terminal 110 that are both coupled to the service provider network 104. The service provider network 104 could also be used to provide communication services between an originating terminal 102 coupled to the service provider network 104 and an end terminal coupled to another service provider network. The embodiment of the service provider network 104 shown in FIG. 3 includes many common components as in the service provider network 104 shown in FIG. 2. The common components are given the same reference numerals. The embodiment of the service provider network 104 shown in FIG. 3 is for illustration only. Other embodiments of the service provider network 104 may be used without departing from the scope of this disclosure.

As shown in FIG. 3, the call processor 202 is coupled to a soft switch 302. The soft switch 302 is capable of facilitating communication between the various components coupled to the soft switch 302. For example, the soft switch 302 may be used to connect a telephone call between the originating terminal 102 and a called end terminal, such as the end terminal 110. The soft switch 302 may also couple the IVR platform 216 or the call center 218 to the originating terminal 102 and/or the end terminal 110 before, during, or after a collect call. The soft switch 302 includes any hardware, software, firmware, or combination thereof for facilitating communication between components in the service provider network 104.

The soft switch 302 or the call processor 202 may include or otherwise implement the validation engine 204 shown in FIG. 2. In this example, information generated during the validation process may be stored in a validation database 304. The information in the database 304 may include, for example, information identifying previous validated requests for service or previous requests that have been rejected.

The soft switch 302 may also provide access to a messaging database 306. The messaging database 306 stores and facilitates retrieval of voice or other messages for the originating terminals 102 and/or end terminals 108-114. For example, when an originating terminal 102 places a telephone call to an end terminal 110, the called party may fail to answer the end terminal 110. In this case, the calling party using the originating terminal 102 may record a message for the called party, and the message is stored in the database 306. At a later time, the called party may access the database 306 and retrieve the message. As another example, if a calling party is calling an end terminal 110 when no prepaid account is available, the calling party may be allowed to record a short message. The message is stored in the database 306 and then delivered to the end terminal 110, allowing the called party to decide whether to establish a prepaid account.

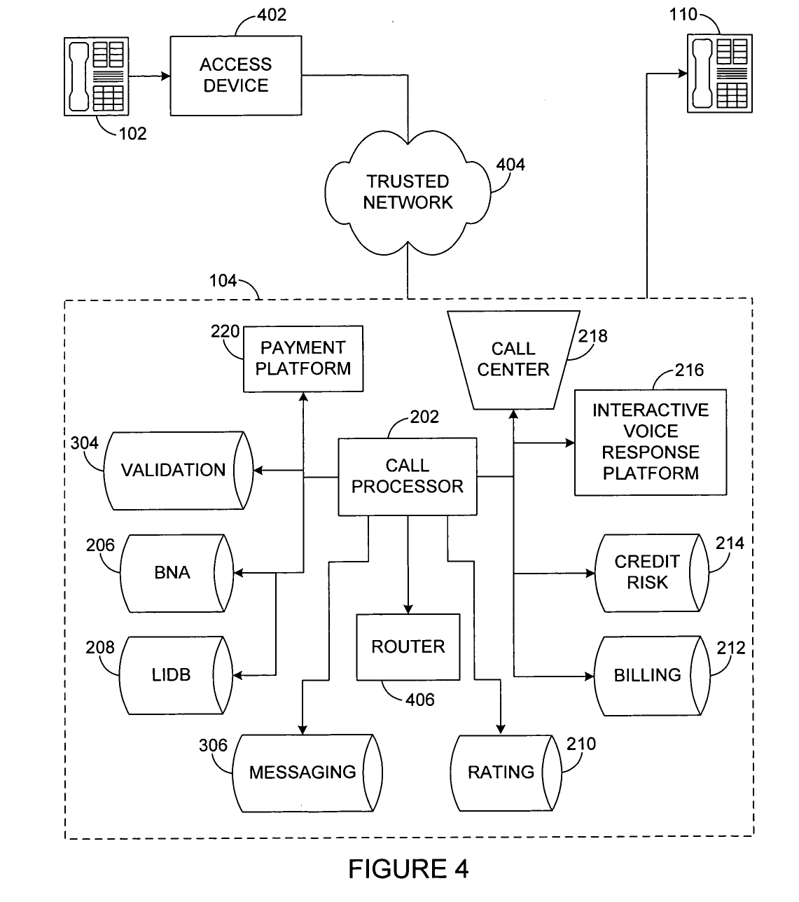

FIG. 4 illustrates a third example service provider network 104 for providing communication services according to one embodiment of this disclosure. In this example, the service provider network 104 is shown as providing communication services between an originating terminal 102 and an end terminal 110 that are both coupled to the service provider network 104. The service provider network 104 could also be used to provide communication services between an originating terminal 102 coupled to the service provider network 104 and an end terminal coupled to another service provider network. The embodiment of the service provider network 104 shown in FIG. 4 includes many common components as in the service provider network 104 shown in FIGS. 2 and 3. The common components are given the same reference numerals. The embodiment of the service provider network 104 shown in FIG. 4 is for illustration only. Other embodiments of the service provider network 104 may be used without departing from the scope of this disclosure.

As shown in FIG. 4, the originating terminal 102 is coupled to an access device 402. In this example, communication services such as telephone calls are transported over one or more data networks, such as an Internet Protocol (“IP”), Asynchronous Transfer Mode (“ATM”), or frame relay network. In this embodiment, the access device 402 is capable of converting analog voice or other signals into digital data and packetizing the digital data into a suitable format. The format could include IP packets, ATM cells, or frame relay frames. The access device 402 is also capable of receiving packetized data and converting the data into analog signals for delivery to the originating terminal 102. The access device 402 could be further capable of compressing data for transmission over a network and decompressing data received over a network. As an example, the access device 402 could implement Voice over Internet Protocol (“VoIP”) compression and decompression. The access device 402 includes any hardware, software, firmware, or combination thereof capable of facilitating communication over a data network.

The access device 402 is coupled to a trusted network 404. The trusted network 404 represents a network that connects the access device 402 and the service provider network 104. For example, if the originating terminal 102 is located in a facility such as a prison, the trusted network 404 may link the facility or group of facilities to the service provider network 104. The trusted network 404 could represent any suitable network or combination of networks, such as a local area network or a wide area network. In other embodiments, the access device 402 may be coupled directly to the service provider network 104.

The service provider network 104 in this embodiment includes a router 406. The router 406 is responsible for routing packetized data, such as voice data, between components in the system 100. For example, the router 406 may route packetized voice data between the originating terminal 102 and the end terminal 110. The router 406 represents any hardware, software, firmware, or combination thereof for routing packetized data in the service provider network 104.

Although FIGS. 2 through 4 illustrate examples of a service provider network 104 for providing communication services, various changes may be made to FIGS. 2 through 4. For example, the functional division of the service provider network 104 shown in FIGS. 2 through 4 is for illustration only. Various components in FIGS. 2 through 4 may be subdivided, combined, or omitted and additional components may be added according to particular needs. Also, while FIGS. 2 through 4 show various databases 206-214 and/or 206-214 and 304-306, the information in the databases may be stored in any suitable number of databases (including a single database). In addition, the various embodiments of the service provider network 104 shown in FIGS. 2 through 4 are for illustration only. Other embodiments of the service provider network 104 may be used in the system 100 of FIG. 1.

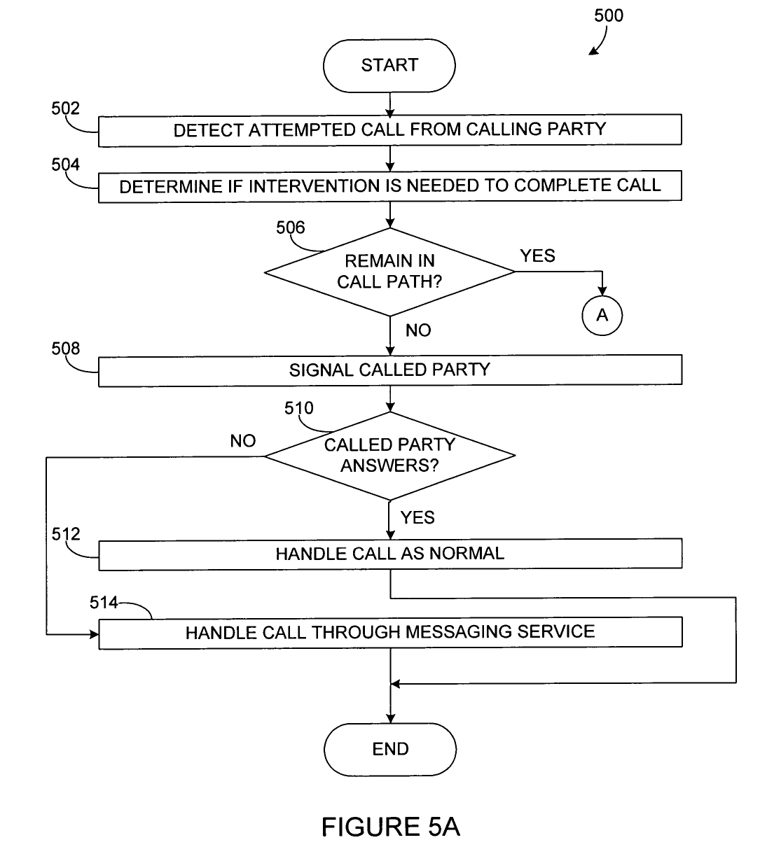

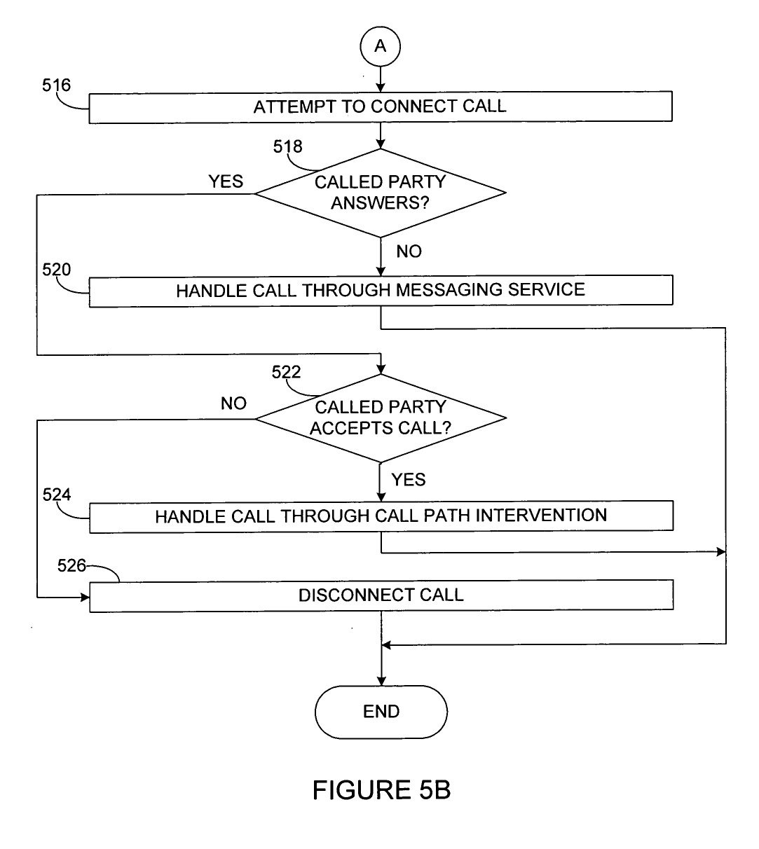

FIGS. 5A and 5B illustrate an example method 500 for providing communication services and intervening when necessary to provide service according to one embodiment of this disclosure. For ease of explanation, the method 500 is described with respect to the system 100 of FIG. 1. The method 500 could be used by any other suitable system.

The first service provider network 104 detects an attempted call from a calling party at step 502. This may include, for example, the first service provider network 104 receiving DTMF tones or other information indicating that a user of the originating terminal 102 is attempting to place a telephone call.

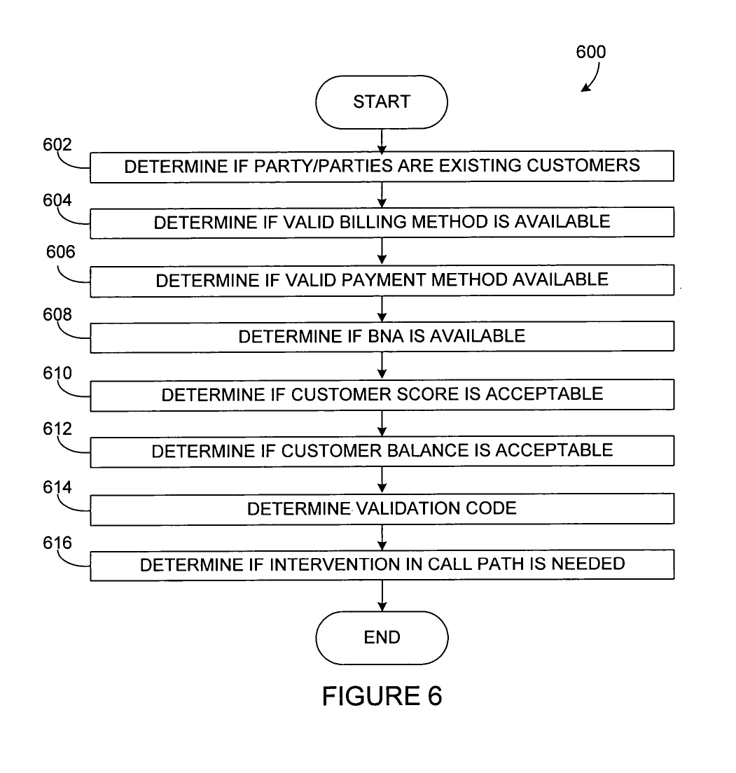

The first service provider network 104 determines if intervention is needed to complete the requested telephone call at step 504. This may include, for example, the first service provider network 104 determining if the call may be billed to one of the parties or deducted from a prepaid account. This may also include the first service provider network 104 determining if a billing name and address for the party to be charged for the telephone call is available. One method for determining if intervention is needed is shown in FIG. 6, which is described below.

The first service provider network 104 determines whether it should remain in the call path and intervene at step 506. This may include, for example, the first service provider network 104 remaining in the call path if some form of intervention is needed to provide the requested service.

If the first service provider network 104 does not need to remain in the call path, the first service provider network 104 signals the called party at step 508. This may include, for example, the first service provider network 104 causing the end terminal 110 used by the called party to ring.

The first service provider network 104 determines if the called party answers the call at step 510. If the called party answers the call, the first service provider network 104 establishes a voice connection and handles the telephone call as usual at step 512. This may include, for example, the first service provider network 104 establishing a voice connection or transporting packetized voice data between the calling and called parties. This may also include the first service provider network 104 collecting information about the charges incurred during the call. This may further include the first service provider network 104 debiting a prepaid account or billing one or more of the parties for the call. The party or parties may be billed directly, through their service provider(s), or in any other suitable manner.

If the called party does not answer the telephone call at step 512, the first service provider network 104 handles the call through a messaging service at step 514. This may include, for example, the first service provider network 104 offering the calling party an option to record a message for the called party. If accepted by the calling party, the calling party records a message, and the first service provider network 104 delivers the message to the called party at a later time. The first service provider network 104 may charge for the use of the messaging service, such as by charging the calling party for leaving the message or the called party for retrieving the message.

If the first service provider network 104 determines at step 506 that it must remain in the call path, the first service provider network 104 attempts to connect the telephone call at step 516. This may include, for example, the first service provider network 104 causing the called party's end terminal 110 to ring.

The first service provider network 104 determines if the called party answers the call at step 518. If not, the first service provider network 104 again gives the calling party the option of using a messaging service at step 520.

Otherwise, if the called party answers the call, the first service provider network 104 gives the called party an opportunity to accept the call at step 522. This may include, for example, the first service provider network 104 informing the called party that a call has been placed to that party. This may also include the first service provider network 104 offering the called party the option of providing information necessary to bill the party for the call. This may further include the first service provider network 104 offering the called party a chance to establish a prepaid account or other mechanism to pay for the call. In addition, this may include the first service provider network 104 informing the called party that the called party owes a balance for previous services and that the balance must be paid before the call is connected.

If the called party accepts the call, the call is handled using intervention at step 524. This may include, for example, the first service provider network 104 receiving a credit card number from the called party and crediting a prepaid account. This may also include the called party engaging in a check by telephone transaction to establish or replenish a prepaid account. This may further include the called party providing a billing name and address or other necessary information to the first service provider network 104 and the first service provider network 104 determining that the called party may be billed for the call. Once a prepaid account or other billing or payment mechanism has been established, the call is connected, and the parties may communicate.

If the called party rejects the call at step 522, the call is disconnected at step 526. This may include, for example, the first service provider network 104 terminating the connection between the originating terminal 102 and the end terminal 110. This may also include adding a “blocked” status to the called party, which prevents the calling party from calling the called party in the future. This may help to prevent the calling party from repeatedly calling the called party. The “blocked” status could be temporary and expire after a specified amount of time.

Using the method 500 shown in FIGS. 5A and 5B, the first service provider network 104 may be able to satisfy more requests for communication services. If the requested service may be provided without any intervention, the requested service is provided. If intervention is needed to provide the service, the intervention may take place at the point of demand, meaning the intervention is attempted while one or more parties are using their terminals 102, 108-114. By intervening in the call path when necessary, the first service provider network 104 may be able to provide requested services more often, resulting in fewer blocked requests.

Although FIGS. 5A and 5B illustrate one example of a method 500 for providing communication services and intervening when necessary to provide service, various changes may be made to FIGS. 5A and 5B. For example, the first service provider network 104 need not offer a messaging service to the calling party when the called party does not answer. Also, the method 500 has been described as providing telephone services in the system 100. The method 500 could also be used to provide any other or additional communication service or services in the system 100. In addition, the first service provider network 104 may connect the calling and called parties before performing any necessary intervention. As an example, the first service provider network 104 may allow the parties to communicate for a limited amount of time before intervening in the call path.

FIG. 6 illustrates an example method 600 for determining whether a service provider should intervene in a communication attempt according to one embodiment of this disclosure. In particular, the method 600 shown in FIG. 6 may be performed during step 504 of the method 500 shown in FIG. 5. For ease of explanation, the method 600 is described with respect to the system 100 of FIG. 1. The method 600 could be used by any other suitable system.

The first service provider network 104 determines if the calling party and/or the called party is an existing customer of the first service provider network 104 at step 602. This may include, for example, determining if the called party in a collect call has an existing business relationship with the service provider.

The first service provider network 104 also determines if a valid billing method is available to bill one or more of the parties for the requested service at step 604. This may include, for example, the first service provider network 104 determining if the called party is served by a different service provider network (such as network 106). If so, the first service provider network 104 may also determine if there is a billing arrangement between the two service providers. If there is not, the first service provider network 104 may be unable to bill the called party through the other service provider.

The first service provider network 104 determines if a valid payment mechanism is available so that one or more of the parties may pay for the requested service at step 606. This may include, for example, the first service provider network 104 determining if a prepaid account, credit card, or other mechanism is available to pay for the requested service.

The first service provider network 104 determines if a valid billing name and address are available for the calling and/or called party at step 608. This may include, for example, the first service provider network 104 accessing the BNA database 206 and using an identifier associated with the calling and/or called party (such as a telephone number). This may also include the first service provider network 104 determining if valid BNA information associated with that identifier is stored in the BNA database 206.

The first service provider network 104 determines if a customer score is acceptable at step 610. This may include, for example, the first service provider network 104 generating a score based on the payment history of the calling party and/or the called party. This may also include the first service provider network 104 using a credit score associated with the calling and/or called party. This may further include the first service provider network 104 comparing the generated or retrieved score to a threshold level.

The first service provider network 104 determines if a balance owed by the calling and/or called party is acceptable at step 612. This may include, for example, the first service provider network 104 determining if the calling party is making a collect call to a called party who has not paid a prior bill. This may also include the first service provider network 104 determining if the calling party is making a collect call to a called party who has already exceeded a maximum amount of collect call charges.

The first service provider network 104 determines a validation code at step 614. This may include, for example, the first service provider network 104 determining if a collect call block has been placed on a called party.

Using the results from one or more of the steps 602-614, the first service provider network 104 determines if intervention is needed in the call path to provide a requested service at step 616. For example, intervention may be needed if the calling and/or called party is a new customer, if no valid billing mechanism and no valid payment mechanism are available, if the party's unpaid balance exceeds a threshold, or if a prepaid account balance falls below a threshold. As another example, intervention may be needed if a valid billing mechanism and BNA are available but the party's payment history or credit score does not allow the call to be billed to the party. As yet another example, intervention may not be needed if a valid payment mechanism (such as a prepaid account) is available to pay for the requested service. Any other or additional criteria may be used to determine whether intervention is needed using the results from one or more of the steps 602-614.

Although FIG. 6 illustrates one example of a method 600 for determining whether a service provider should intervene in a communication attempt, various changes may be made to FIG. 6. For example, the method 600 is shown as performing steps 602-614 in series before step 616 is performed. In other embodiments, various steps 602-614 may be skipped. As a particular example, steps 604-614 could be skipped if the first service provider network 104 determines that the calling and/or called party is a new customer at step 602. As another particular example, steps 608-614 could be skipped if the first service provider network 104 determines that no valid billing mechanism and no valid payment mechanism can be used to charge a party for the requested service.

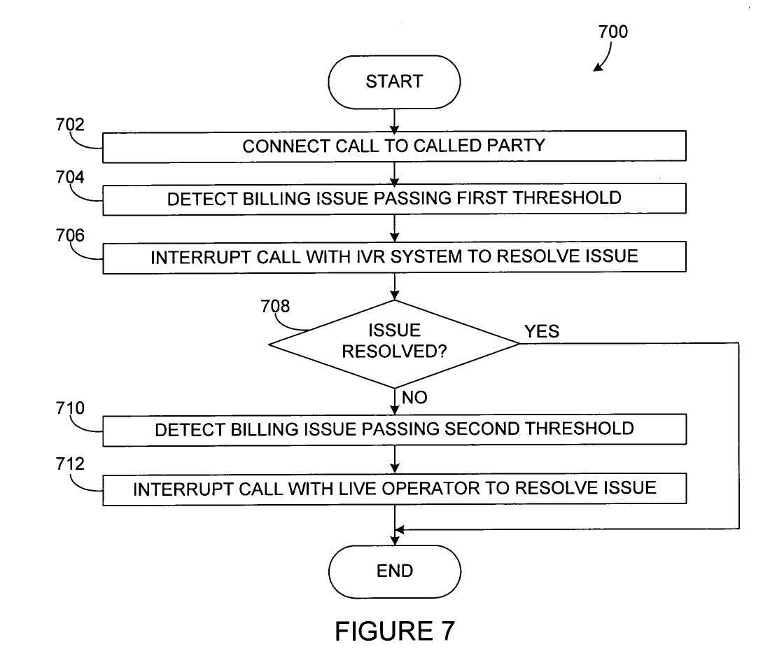

FIG. 7 illustrates an example method 700 for resolving billing issues during an established communication session according to one embodiment of this disclosure. For ease of explanation, the method 700 is described with respect to the system 100 of FIG. 1. The method 700 could be used by any other suitable system.

The first service provider network 104 connects a telephone call to a called party at step 702. At this point, the first service provider network 104 begins charging the calling and/or called party for the telephone call. This may take the form of debiting a prepaid account, charging an account to be billed to the party, or in other suitable manner.

The first service provider network 104 detects a billing issue passing a first threshold at step 704. This may include, for example, the first service provider network 104 determining that a prepaid account has fallen below a particular balance. This may also include the first service provider network 104 determining that the amount to be billed to a party has exceeded a particular value.

The first service provider network 104 intervenes in the call with an automated message in an attempt to resolve the issue at step 706. This may include, for example, the IVR platform 216 generating an audible warning that a prepaid account balance has fallen below a particular amount and giving one of the parties the opportunity to replenish the account. This may also include the IVT platform 216 generating an audible warning that the balance to be billed to one of the parties has exceeded a threshold and that the party may need to pay the balance or establish a prepaid account.

The first service provider network 104 determines if the issue is resolved at step 708. This may include, for example, the first service provider network 104 determining if one of the parties has established or replenished a prepaid account or has paid an outstanding balance. If the issue is resolved, the method 700 ends, and the established call may continue.

Otherwise, the first service provider network 104 monitors the call and detects the billing issue passing a second threshold at step 710. This may include, for example, the first service provider network 104 determining that a prepaid account has fallen below a second threshold balance. This may also include the first service provider network 104 determining that the amount to be billed to a party has passed a second amount.

The first service provider network 104 intervenes in the call with a live operator in an attempt to resolve the issue at step 712. This may include, for example, an operator in the call center 218 placing one of the parties on hold, contacting the other party, and attempting to resolve the billing issue. The operator may give the party an opportunity to pay a balance or establish or replenish a prepaid account.

At this point, the billing issue may or may not have been resolved. If the issue is resolved, the established call may be allowed to proceed. Otherwise, the established call may be terminated when the prepaid account reaches a zero balance or the maximum balance to be billed to a party is reached.

Although FIG. 7 illustrates one example of a method 700 for resolving billing issues during an established communication session, various changes may be made to FIG. 7. For example, FIG. 7 illustrates that two different methods are used to resolve an issue depending on which of two thresholds has been passed. In other embodiments, a single mechanism or other or additional mechanisms could be used when one or multiple thresholds have been passed.

It may be advantageous to set forth definitions of certain words and phrases that have been used within this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, software, firmware, or combination thereof. It should be noted that the functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method, comprising:
receiving a request for a communication service;
determining if intervention is required to provide the communication service;
providing the communication service if no intervention is required;
performing an intervention in response to the request to gather information from at least one party associated with the request if intervention is required; and
providing the communication service after the intervention is completed, wherein providing the communication service comprises using the gathered information to charge the at least one party for the communication service.

2. The method of claim 1, wherein:
the request comprises one of multiple requests; and
at least one intervention is performed for every request associated with a communication service that cannot be provided immediately.

3. The method of claim 1, wherein:
determining if intervention is required comprises using a hierarchy of conditions to determine if intervention is required, the conditions in the hierarchy evaluated based on their positions within the hierarchy; and
some of the conditions in the hierarchy are not evaluated based on the evaluation of at least one other condition in the hierarchy.

4. The method of claim 1, wherein determining if intervention is required comprises at least one of:
determining if the at least one party is a new customer of a service provider receiving the request;
determining if a valid billing mechanism is available for billing the at least one party for the communication service;
determining if a valid payment mechanism is available to allow the at least one party to pay for the communication service;
determining if a valid billing name and address associated with the at least one party is available;
determining if a score associated with the at least one party is acceptable, the score based at least partially on one or more of: a payment history of the at least one party and a credit history of the at least one party; and
determining if a balance associated with the at least one party is acceptable.

5. The method of claim 4, wherein determining if intervention is required further comprises at least one of:
determining that intervention is required when the at least one party is a new customer;
determining that intervention is required when no valid billing mechanism and no valid payment mechanism are available;
determining that intervention is required when a valid billing mechanism is available but no valid billing name and address is available;
determining that intervention is required when a valid billing mechanism and billing name and address are available but the score associated with the at least one party is not acceptable; and
determining that intervention is required when the balance associated with the at least one party violates a threshold.

6. The method of claim 1, further comprising:
monitoring the communication service as the communication service is provided; and
performing a second intervention during the communication service to resolve a billing issue.

7. The method of claim 6, wherein:
the intervention comprises at least one of: a request to establish a prepaid account, a request to pay an existing balance owed by the at least one party, and a request to provide a billing name and address, wherein each request in the intervention comprises one of: an automated request and a live request; and
the billing issue comprises at least one of a prepaid account balance falling below a first threshold and an account balance to be billed to the at least one party exceeding a second threshold.

8. The method of claim 1, wherein performing the intervention comprises:
allowing a plurality of parties to communicate for a limited amount of time; and
performing the intervention after the parties have communicated for the limited amount of time.

9. The method of claim 1, wherein:
the at least one party comprises a calling party located in a secure facility and a called party; and
determining if intervention is required comprises determining if intervention is required in real-time.

10. The method of claim 1, wherein determining if intervention is required comprises:
determining that intervention is required for the request; and
overriding the determination that intervention is required.

11. The method of claim 10, wherein overriding the determination comprises:
determining that the request is made during a holiday; and
providing the communication service comprises establishing a conference call.

12. A system, comprising:
a call processor capable of receiving a request for a communication service;
a validation engine capable of determining if intervention is required to provide the communication service; and
at least one intervention unit capable of performing an intervention in response to the request to gather information from
at least one party associated with the request if intervention is required;
wherein the call processor is further capable of providing the communication service if no intervention is required and providing the communication service after the intervention is completed, wherein the gathered information is used to charge the at least one party for the communication service.

13. The system of claim 12, wherein the validation engine comprises one of:
a stand-alone unit separate from the call processor;
a portion of the call processor; and
a portion of a soft switch.

14. The system of claim 12, wherein:
the validation engine is capable of determining if intervention is required using a hierarchy of conditions, the conditions in the hierarchy evaluated based on their positions within the hierarchy; and
some of the conditions in the hierarchy are not evaluated based on the evaluation of at least one other condition in the hierarchy.

15. The system of claim 12, wherein the validation engine is capable of determining if intervention is required by at least one of:
determining if the at least one party is a new customer of a service provider receiving the request;
determining if a valid billing mechanism is available for billing the at least one party for the communication service;
determining if a valid payment mechanism is available to allow the at least one party to pay for the communication service;
determining if a valid billing name and address associated with the at least one party is available;
determining if a score associated with the at least one party is acceptable, the score based at least partially on one or more of: a payment history of the at least one party and a credit history of the at least one party; and
determining if a balance associated with the at least one party is acceptable.

16. The system of claim 15, wherein the validation engine is further capable of determining if intervention is required by at least one of:
determining that intervention is required when the at least one party is a new customer;
determining that intervention is required when no valid billing mechanism and no valid payment mechanism are available;
determining that intervention is required when a valid billing mechanism is available but no valid billing name and address is available;
determining that intervention is required when a valid billing mechanism and billing name and address are available but the score associated with the at least one party is not acceptable; and
determining that intervention is required when the balance associated with the at least one party violates a threshold.

17. The system of claim 12, wherein the at least one intervention unit comprises at least one of: an automated interactive voice response platform and a call center; and
further comprising at least one payment platform capable of facilitating payment for the communication service and at least one database capable of storing information used by the validation engine.

18. The system of claim 12, wherein the validation engine is capable of determining if intervention is required by:
determining that intervention is required for the request; and
overriding the determination that intervention is required.

19. A computer program embodied on at least one computer readable medium and operable to be executed by at least one processor, the computer program comprising computer readable program code for:
determining if intervention is required to provide a communication service that has been requested;
allowing the communication service to be provided if no intervention is required;
initiating an intervention in response to the request to gather information from at least one party associated with the request if intervention is required; and
allowing the communication service to be provided after the intervention is completed, wherein providing the communication service comprises using the gathered information to charge the at least one party for the communication service.

20. A validation engine, comprising:
at least one memory capable of storing information related to at least one party associated with a communication service that has been requested; and
at least one processor capable of:
determining if intervention is required to provide the communication service using at least some of the information in the memory;
allowing the communication service to be provided if no intervention is required;
initiating an intervention in response to the request to gather information from the at least one party if intervention is required; and
allowing the communication service to be provided after the intervention is completed, wherein the gathered information is used to charge the at least one party for the communication service.
